(19) United States
(12) Patent Application Publication
(10) Pub. No.: US 2021/0357053 A1
(43) Pub. Date: Nov. 18, 2021

(54) TOUCH DISPLAY DEVICE AND MANUFACTURING METHOD THEREOF

(71) Applicant: HUIZHOU CHINA STAR OPTOELECTRONICS TECHNOLOGY CO., LTD., Huizhou (CN)

(72) Inventors: Quan LI, Huizhou (CN); Yuchun HSIAO, Huizhou (CN); Guofu TANG, Huizhou (CN)

(73) Assignee: HUIZHOU CHINA STAR OPTOELECTRONICS TECHNOLOGY CO., LTD., Huizhon (CN)

(21) Appl. No.: 16/618,806

(22) PCT Filed: Oct. 31, 2019
(86) PCT No.: PCT/CN2019/114569

§ 371 Date: Dec. 3, 2019

(30) Foreign Application Priority Data
Jul. 15, 2019 (CN) 201910636508.3

(51) Int. Cl. G06F 3/041; G06F 3/042

(52) U.S. Cl. CPC G06F 3/0412; G06F 2203/04103; G06F 3/0421

(57) ABSTRACT

A touch display device and manufacturing method thereof, and the touch display device includes a display panel, a touch panel, an optical clear adhesive layer, a diffuse reflection film layer, and a cover plate. The touch panel is disposed on a surface of a side of the display panel; the optical clear adhesive layer is disposed on a surface of a side of the display panel away from the touch panel, and the optical clear adhesive layer encircles to form a vacuum region close to an edge of the touch panel; the diffuse reflection film layer is disposed in the vacuum region; and the cover plate is disposed on a surface of a side of the optical clear adhesive layer and the diffuse reflection film layer away from the display panel.

### FIELD OF INVENTION

The present disclosure relates to the field of display, and particularly relates to a touch display device and manufacturing method thereof.

### BACKGROUND OF INVENTION

In the field of display, infrared touch currently dominates a large part of the market with its mature technology, accurate touch accuracy, and relative cost advantages. The disadvantage of infrared touch is that it is required for applicable occasions. Infrared touch is not suitable for occasions with strong light. When sunlight directly irradiates on a touch surface, it has a certain influence on touch accuracy. Infrared touch is analyzed a touch position by blocking infrared light emitted by an infrared frame. It is conceivable that there will be an influence on touch when there are dust, water droplets, etc. Therefore, in occasions of indoor cleaning scenes without strong light, the method of infrared touch is selected to use.

The capacitive touch display device can be simply regarded as a screen composed of a four-layer composite screen, the outermost layer is a glass protective layer, followed by a conductive layer, the third layer is a non-conductive glass screen, and the innermost fourth layer is also a conductive layer. The innermost conductive layer is a shielding layer, which acts as effect of shielding internal electrical signals. The middle conductive layer is a key part of the entire touch screen, and there are directed leads on the four corners or the four sides, which are responsible for detecting positions of touch points. Nowadays, with cost of capacitors gradually reducing, and specification sizes getting larger and larger, advantages of which, such as high sensitivity, strong anti-interference ability, wide application scenes, and small influence on appearance of a machine, the capacitive touch differentiates market share of infrared touch at a rapid speed, thereby the capacitive touch demonstrated by its relatively sensitive touch and being used and accepted by more and more users. In the field of display, as educational whiteboards and high-end conference machines for convenience of operation and demonstration, large-size touch technology is required. The current mainstream touch technology is infrared technology, and the user's touch experience is poor due to the reason of an expensive price and security problems.

As illustrated in FIG. 1 to FIG. 2, in prior art, a touch display device includes a display panel 1, a touch panel 2, an optical clear adhesive layer 3, a cover plate 4, and a vacuum region 10. The touch panel 2 is disposed on an upper surface of the display panel 1; the optical clear adhesive layer 4 is disposed on an edge of the touch panel 2; the cover 4 is disposed on an upper surface of the touch panel 2 and the optical clear adhesive layer 4; and the vacuum region 10 is disposed on a middle section of the optical clear adhesive layer. In a vacuum environment, performing a heat process on the cover plate 4 and the touch panel 2, and performing a vacuum process by a vacuum pump on the vacuum region 10, the optical clear adhesive layer 4 makes the cover plate 4 and the touch panel 2 be closely bonded. However, due to the optical clear adhesive layer 4 has a certain thickness, causing the cover plate 4 to interfere with the touch panel 2 to form an air tip region 20, which not only affects the picture quality of the touch display device, when users operate on the cover plate, due to the presence of the air tip region 20 results in low sensitivity of a touch, but also further affects users' experiences.

### SUMMARY OF INVENTION

The purpose of the present disclosure is to provide a display device and manufacturing method thereof to solve the technical problem of poor quality of pictures, low sensitivity of touch, and poor users' tactile experience of touch display devices existing in the prior art.

In order to realize the purpose mentioned above, the present disclosure provides a touch display device, including a display panel, a touch panel, an optical clear adhesive layer, a diffuse reflection film layer, and a cover plate. The touch panel is disposed on a surface of a side of the display panel; the optical clear adhesive layer is disposed on a surface of a side of the display panel away from the touch panel, and the optical clear adhesive layer encircles to form a vacuum region close to an edge of the touch panel; the diffuse reflection film layer is disposed in the vacuum region; and the cover plate is disposed on a surface of a side of the optical clear adhesive layer and the diffuse reflection film layer away from the display panel.

Further, the diffuse reflection film layer fully fills the vacuum region.

Further, material of the diffuse reflection film layer is polyethylene terephthalate.

Further, a shape of the optical clear adhesive layer is a ring shape.

Further, a shape of the touch panel is same as a shape of the display panel; and a size of the touch panel is same as a size of the display panel.

In order to realize the purpose mentioned above, the present disclosure further provides a manufacturing method for a touch display device. A step of disposing a touch panel, bonding the touch panel on an upper surface of a display panel, and an edge of the touch panel corresponding to an edge of the display panel; a step of disposing strip adhesive blocks, bonding the strip adhesive blocks on an upper surface of the touch panel, and a location of the strip adhesive blocks disposed on an edge of the touch panel, and at least one of the strip adhesive blocks encircling to form a vacuum region; a step of disposing a diffuse reflection film, disposing the diffuse reflection film in the vacuum region, and bonding the diffuse reflection film to an upper surface of the touch panel to form a diffuse reflection film layer; a step of disposing a cover plate, disposing the cover plate on an upper surface of the strip adhesive blocks and the diffuse reflection film layer, and making a middle section of the cover plate disposed opposite the touch panel and the display panel; a step of heating, under a vacuum environment, performing a heating process on the cover plate and the touch panel to melt the strip adhesive blocks; and a step of curing, applying ultraviolet to irradiate the cover plate and the touch panel to make the melted strip adhesive blocks cure into an optical clear adhesive layer.

Further, a thickness of the optical clear adhesive layer is less than a thickness of the strip adhesive blocks; a thickness of the diffuse reflection film layer is same as a thickness of the optical clear adhesive layer.

In order to realize the purpose mentioned above, the present disclosure further provides a manufacturing method for a touch display device, including following steps: a step of disposing a touch panel and a diffuse reflection film layer, attaching the touch panel on an upper surface of a display panel, and attaching at least one of strip adhesive blocks and the diffuse reflection film layer on a bottom surface of a cover plate; a step of attaching, attaching the strip adhesive blocks and a bottom surface of the diffuse reflection film layer to an upper surface of the touch panel, and an edge of the touch panel corresponding to an edge of the strip adhesive blocks; a step of disposing the display panel, disposing the display panel under the touch panel to make the display panel align to the touch panel and the cover plate; a step of heating, under a vacuum environment, performing a heating process on the cover plate and the touch panel, making the strip adhesive blocks be melted; and a step of curing, applying ultraviolet to irradiate the cover plate and the touch panel to make the melted strip adhesive blocks cure into an optical clear adhesive layer.

Further, the step of disposing the touch panel and the diffuse reflection film layer includes: a step of disposing strip adhesive blocks, attaching the strip adhesive blocks on a preset location of a lateral surface of the touch panel, and the strip adhesive blocks encircling to form a vacuum region; and a step of disposing a diffuse reflection film, disposing the diffuse reflection film in the vacuum region, and attaching the diffuse reflection film to a surface of the touch panel to form a diffuse reflection film layer.

Further, the step of disposing the touch panel and the diffuse reflection film layer includes a step of disposing a touch panel, attaching the touch panel on an upper surface of a display panel, and an edge of the touch panel corresponding to an edge of the display panel.

The technical effect of the present disclosure is that providing a touch display device and a manufacturing method thereof, disposing the diffuse reflection film layer between the cover plate and the touch panel, and the diffuse reflection film layer is encircled by the optical clear adhesive layer; a thickness of the diffuse reflection film layer is same as a thickness of the optical clear adhesive layer to eliminate an air tip region existing in prior art, making the touch panel be fully and closely bonded to the cover plate to improve picture quality of the touch display device, and to improve touch sensitivity, thereby improving users' experiences; in addition, the diffuse reflection film layer can improve explosion-proof performance of the cover plate, thereby improving quality of the touch display device.

### DESCRIPTION OF DRAWINGS

To more clearly illustrate the technical solutions of the embodiments of the present disclosure, the accompanying figures of the present disclosure will be described in brief. Obviously, the accompanying figures described below are only part of the embodiments of the present disclosure, from which figures those skilled in the art can derive further figures without making any inventive efforts.

FIG. 1 is a structural schematic diagram of a touch display device in prior art.

FIG. 2 is a structural schematic diagram of a touch display device in prior art after being pressed fit.

FIG. 3 is a structural schematic diagram of a touch display device provided by the first embodiment after being pressed fit.

FIG. 4 is a flowchart of a touch display device provided by the first embodiment.

FIG. 5 is a structural schematic diagram of a touch display device provided by the first embodiment.

FIG. 6 is another flowchart of a touch display device provided by the second embodiment.

FIG. 7 is a flowchart of a step of attaching provided by the second embodiment.

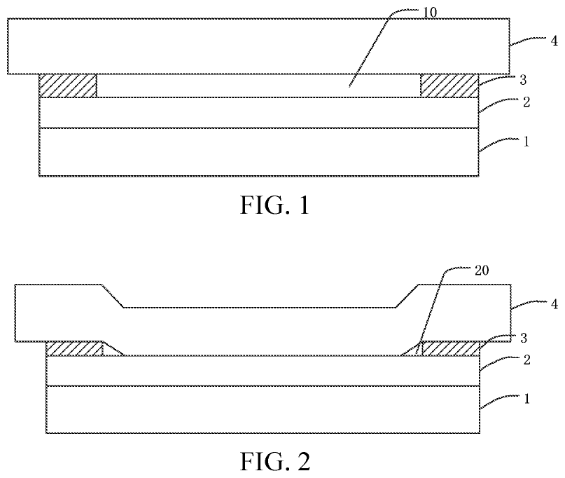

### DETAILED DESCRIPTION OF PREFERRED EMBODIMENTS

The preferred embodiments of the present disclosure are described below with reference to the accompanying drawings, which are used to take examples and exemplify the present disclosure can be implemented. The technical contents of the present disclosure can be fully described to those skilled in the art from these embodiments to make the technical content of the present disclosure be clearly and more easily to understand. However, the present disclosure can be presented in many different forms of embodiments, and the scope of the present disclosure is not limited to the embodiments set forth herein.

The terms “first”, “second”, and the like (if there are any) in the specification, claims, and the accompanying drawings mentioned above of the present disclosure are used to distinguish similar objects, and are not necessarily used to describe a particular order or a sequential order.

It should be understood, that the objects described are interchangeable under an appropriate situation. Moreover, the terms “comprising” and “having” and any deformation of them are intended to cover non-exclusive inclusions.

### The First Embodiment

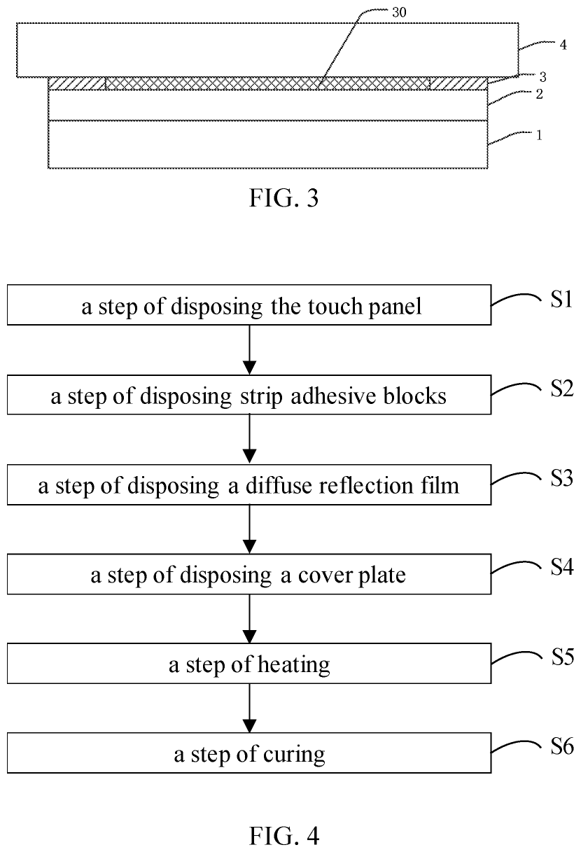

As illustrated in FIG. 3, this embodiment provides a touch display device including a display panel 1, a touch panel 2, an optical clear adhesive layer 3, a diffuse reflection film layer 30, and a cover plate 4.

The display panel 1 can be a liquid crystal display panel, an organic light emitting diode display panel, an active matrix organic light emitting diode display panel, a macromolecule light emitting diode display panel, etc., this embodiment is not limited.

The touch panel 2 is disposed on an upper surface of the display panel 1. A shape of the touch panel 2 is same as a shape of the display panel; a size of the touch panel 2 is same as a size of the display panel 1, which can effectively ensure that an operable region of the touch panel 2 is consistent with an operable region of the display panel 1.

The optical clear adhesive 3 is disposed on an upper surface of the touch panel 2, and it is close to an edge of the touch panel; a shape of the optical clear adhesive layer 3 is a ring shape, encircling to form a vacuum region 10. The vacuum region 10 is fully filled by the diffuse reflection film layer 30. A thickness of the optical clear adhesive layer 3 is same as a thickness of the diffuse reflection film layer 30. In this embodiment, a shape of the optical clear adhesive layer 3 is preferred to be a rectangular ring, and center of the rectangular ring is the vacuum region 10. Material of the optical clear adhesive layer 3 is solid optically clear adhesive (SCA), which is a curable optical clear adhesive. It can be cured under a condition of an ultraviolet irradiation. The cured optical clear adhesive has an excellent weather fastness, and particularly has an excellent anti-extension performance and an explosion-proof performance, which greatly improves security, reliability, durability, and aesthetic of the field of display, and has characteristics, such as high photopic ratio, high bonding intensity, low haze, a low contraction ratio, and resistance to yellowing. It is primarily applicable in the field of full bonding, such as medium or large size computers, liquid crystal displays, and integrated machines. Material of the diffuse reflection film layer 30 is polyethylene terephthalate (PET), which has characteristics, such as a great explosion-proof performance, a great transparent ratio, a great performance of electrical insulation, and high-temperature resistance.

The glass cover plate 4 is disposed on an upper surface of the optical clear adhesive layer 3 and the diffuse reflection film layer 30. In this embodiment, the cover plate 3 is preferred to be a glass cover plate.

Specifically, in bonding effect of the optical clear adhesive layer 3 and the diffuse reflection film layer 30, the cover plate 4 and the touch panel 2 is bonded to each other. In atmospheric pressure effect, the diffuse reflection film layer 30 fully fills the vacuum region 10, making there is no gap between the cover plate 4 and the touch panel 2, so that the touch panel 2 fully and closely bonds to the cover plate 4. A thickness of the diffuse reflection film layer is same as a thickness of the optical clear adhesive layer. Therefore, an interference phenomena will not occur on the cover plate and the touch panel due to the thickness of the optical clear adhesive layer, which eliminates an air tip region existing in prior art to improve picture quality of the touch display device, and to improve touch sensitivity, thereby improving users' experiences. Further, the optical clear adhesive layer and the diffuse reflection film layer make the touch panel fully and closely bond to the cover plate, which can improve an explosion-proof performance of the cover plate. Compared with prior art, in touch display devices of prior art, only the optical clear adhesive layer can improve an explosion-proof performance of a cover plate. In this embodiment, making the diffuse reflection film layer be attached to the middle section of the cover plate and fully fill the vacuum region, the explosion-proof performance of the cover plate can be enhanced. Through improving the explosion-proof performance of the cover plate, can further improve quality of the touch display device.

As illustrated in FIG. 4, this embodiment further provides a manufacturing method for a touch display device, including the following step S1 to step S6.

S1: a step of disposing the touch panel, attaching a touch panel on an upper surface of the display panel, and an edge of the touch panel corresponding to an edge of the display panel, which can effectively ensure that an operable region of the touch panel is consistent with an operable region of the display panel.

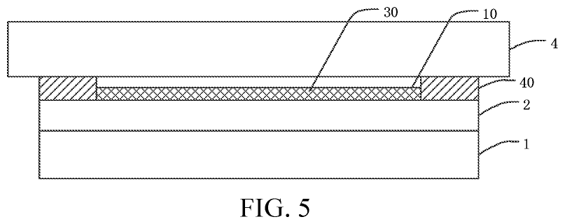

As illustrated in FIG. 5, S2: a step of disposing strip adhesive blocks, adopting a cutter die cutting method or a laser cutting method to make the optical clear adhesive in solid state be cut into strip adhesive blocks; attaching the strip adhesive blocks 40 on an upper surface of the touch panel 2, and a location of the strip adhesive blocks 40 is disposed on an edge of the touch panel 2, and at least one of the strip adhesive blocks 40 encircles to form a vacuum region 10. Specifically, the locations of the strip adhesive blocks 40 are disposed opposite to four edges of the touch panel 2, the four strip adhesive blocks 40 are connected head-to-tail to encircle to form a rectangular ring. Further, the contact locations of the four strip adhesive blocks 40 may overlap or may not overlap, and the embodiment is not limited. In addition, in this embodiment, those skilled in the art can define a width of the strip adhesive blocks according to actual requirements.

S3: a step of disposing a diffuse reflection film, disposing the diffuse reflection film in the vacuum region 10, and attaching the diffuse reflection film to an upper surface of the touch panel 2 to form a diffuse reflection film layer 30, referring to FIG. 5. The diffuse reflection film layer 30 has great explosion-proof performance, which can improve an explosion-proof performance of the touch display device. Further, a thickness of the diffuse reflection film layer 30 is less than a thickness of the strip adhesive blocks 40; a ratio of the thickness between the diffuse reflection film layer 30 and the strip adhesive blocks 40 ranges from 0.3 to 0.7.

S4: a step of disposing a cover plate, disposing a cover plate on an upper surface of the strip adhesive blocks and the diffuse reflection film layer; adopting an alignment method with a charge-coupled device (CCD) or an positioning method with assistance of a jig to make the cover plate be aligned to the touch panel and the display panel. Because the size of the cover plate is larger than the size of the touch panel, it is required to make the touch panel dispose opposite the middle section of the display panel, that is, the cover is aligned to the touch panel and the display panel.

S5: a step of heating, sending the cover plate, the touch panel and the display panel into a vacuum chamber; under a vacuum environment, performing a heating process on the cover plate and the touch panel; when the strip adhesive blocks is heated in to 65° C. to 75° C., the strip adhesive blocks melt to form a rectangular ring, and center of the rectangular ring is the diffuse reflection film layer. The strip adhesive blocks melt and flow to be flat under the double effect of heating and pressurizing, so that the edge of the cover plate is closely bonded to the edge of the touch panel under the bonding effect of the optical clear adhesive, referring to FIG. 3, Because there is no diffuse reflection film layer on the middle section of the rectangular ring, an interfere phenomena will not occur on the cover plate and the touch panel under the double effect of heating and pressurizing, thereby eliminating the air tip existing in prior art.

S6: a step of curing, applying ultraviolet to irradiate the cover plate and the touch panel to make the melted strip adhesive blocks cure into an optical clear adhesive layer, a shape of the optical clear adhesive layer is a rectangular ring, and the middle section of the rectangular ring is the diffuse reflection film layer, referring to FIG. 3.

In this embodiment, compared a thickness of the optical clear adhesive layer with a thickness of the strip adhesive blocks, the thickness of the optical clear adhesive layer is less than the thickness of the strip adhesive blocks. Because the thickness of the optical clear adhesive layer is same as the thickness of the diffuse reflection film layer, and a ratio of the thickness between the diffuse reflection film layer and the strip adhesive blocks ranges from 0.3 to 0.7. Therefore, a ratio of the thickness between the optical clear adhesive layer and the strip adhesive blocks ranges from 0.3 to 0.7.

This embodiment provides a touch display device and a manufacturing method thereof. Disposing the diffuse reflection film layer between the cover plate and the touch panel, and the diffuse reflection film layer is encircled by the optical clear adhesive layer; a thickness of the diffuse reflection film layer is same as a thickness of the optical clear adhesive layer to eliminate an air tip region existing in prior art, making the touch panel be fully and closely bonded to the cover plate to improve picture quality of the touch display device, and to improve touch sensitivity, thereby improving users' experiences; in addition, the diffuse reflection film layer can improve explosion-proof performance of the cover plate, thereby improving quality of the touch display device.

### The Second Embodiment

This embodiment includes most of the technical solutions of the first embodiment, and the distinguishing feature is that the manufacturing steps of the manufacturing method for the touch display device are different, but the technical effects are the same.

The manufacturing method of the touch display device includes a step of disposing the touch panel and the diffuse reflection film layer, a step of attaching, a step of disposing the display panel, a step of heating, and a step of curing.

In the step of disposing the touch panel and the diffuse reflection film layer, attaching the touch panel on an upper surface of a display panel, and attaching at least one of the strip adhesive blocks and the diffuse reflection film layer on a bottom surface of a cover plate.

In the step of attaching, attaching the strip adhesive blocks and a bottom surface of the diffuse reflection film layer to an upper surface of the touch panel, and an edge of the touch panel corresponding to an edge of the strip adhesive blocks.

In the step of disposing the display panel, disposing the display panel under the touch panel to make the display panel align to the touch panel and the cover plate. In the step of heating, under a vacuum environment, performing a heating process on the cover plate and the touch panel to make the strip adhesive blocks be melted.

In the step of curing, applying ultraviolet to irradiate the cover plate and the touch panel to make the melted strip adhesive blocks cure into an optical clear adhesive layer.

Further, the step of disposing the touch panel and the diffuse reflection film layer includes a step of disposing strip adhesive blocks, a step of disposing a diffuse reflection film, and a step of disposing the touch panel.

In the step of disposing strip adhesive blocks, attaching the strip adhesive blocks on a preset location of a lateral surface of the cover plate, and the strip adhesive blocks encircling to form a vacuum region.

In the step of disposing a diffuse reflection film, disposing the diffuse reflection film in the vacuum region, and attaching the diffuse reflection film to a surface of the touch panel to form a diffuse reflection film layer.

In the step of disposing the touch panel, attaching the touch panel on an upper surface of the display panel, and an edge of the touch panel corresponding to an edge of the display panel.

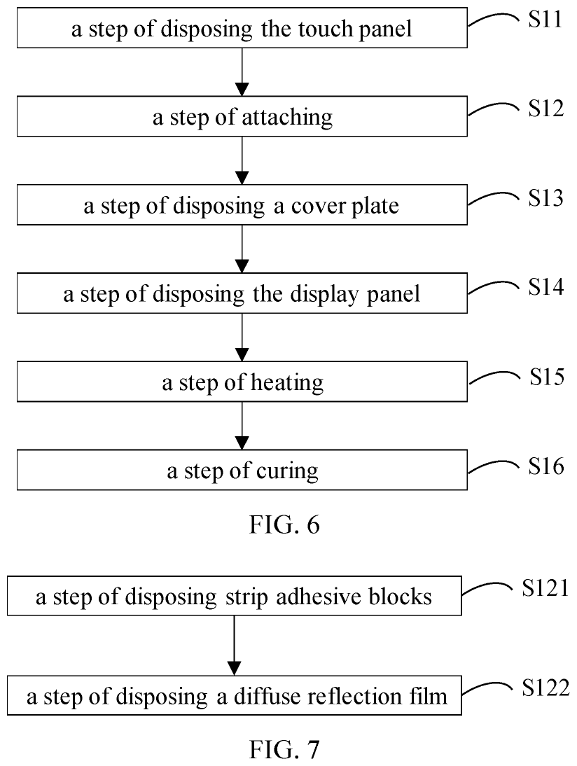

As illustrated in FIG. 6, in a process of actual processes, the manufacturing order of the manufacturing method of the touch display device is from S11 to S16.

S11: a step of disposing the touch panel, attaching the touch panel on an upper surface of the display panel, and an edge of the touch panel corresponding to an edge of the display panel.

S12: a step of attaching, attaching the strip adhesive blocks and a bottom surface of the diffuse reflection film layer to an upper surface of the touch panel, and an edge of the touch panel corresponding to an edge of the strip adhesive blocks.

As illustrated in FIG. 7, the step of attaching includes S121 and S122. Specifically, S121: a step of disposing strip adhesive blocks, attaching the strip adhesive blocks on a preset location of a lateral surface of the cover plate, and the strip adhesive blocks encircling to form a vacuum region. S122: a step of disposing a diffuse reflection film, disposing the diffuse reflection film in the vacuum region, and attaching the diffuse reflection film to a surface of the touch panel to form a diffuse reflection film layer.

S13: a step of disposing a cover plate, flipping the cover plate; attaching the strip adhesive blocks and a bottom surface of the diffuse reflection film layer to an upper surface of the touch panel, and an edge of the touch panel corresponding to an edge of the strip adhesive blocks.

S14: a step of disposing the display panel, disposing the display panel under the touch panel to make the display panel align to the touch panel and the cover plate.

S15: a step of heating, under a vacuum environment, performing a heating process on the cover plate and the touch panel to make the strip adhesive blocks be melted.

S16: a step of curing, applying ultraviolet to irradiate the cover plate and the touch panel to make the melted strip adhesive blocks cure into an optical clear adhesive layer.

This embodiment provides a touch display device and a manufacturing method thereof. Disposing the diffuse reflection film layer between the cover plate and the touch panel, and the diffuse reflection film layer is encircled by the optical clear adhesive layer; a thickness of the diffuse reflection film layer is same as a thickness of the optical clear adhesive layer to eliminate an air tip region existing in prior art, making the touch panel be fully and closely bonded to the cover plate to improve picture quality of the touch display device, and to improve touch sensitivity, thereby improving users' experiences; in addition, the diffuse reflection film layer can improve explosion-proof performance of the cover plate, thereby improving quality of the touch display device.

### The Third Embodiment

This embodiment includes most of the technical solutions of the second embodiment. This embodiment exchanges the manufacturing sequential order of the step of attaching and the step of disposing the touch panel. The manufacturing method for the touch display device in sequence is the step of attaching, the step of disposing the touch panel, the step of disposing the cover plate, the step of disposing the display panel, the step of heating, and the step of curing. Although this embodiment exchanges the manufacturing sequential order of the step of attaching and the step of disposing the touch panel, the technical effect is the same as that of the second embodiment.

### The Fourth Embodiment

This embodiment includes most of the technical solutions of the second embodiment. In this embodiment, the step of disposing the touch panel and the step of attaching can be synchronously execute, thereby saving time and improving work efficiency. After the step of disposing the touch panel or the step of attaching, executing follow-up steps sequentially, that is, the step of disposing the cover plate, the step of disposing the display panel, the step of heating, and the step of curing. This embodiment provides a touch display device and manufacturing method thereof, and technical effects of which not only include the technical effect of the second embodiment, but also can save time and improve work efficiency.

Which mentioned above is preferred embodiments of the present disclosure, it should be noted that to those skilled in the art without departing from the technical principle of the present disclosure, can further make many changes and modifications, and the changes and the modifications should be considered as the scope of protection of the present disclosure.

1. A touch display device, comprising:
a display panel;
a touch panel disposed on a surface of a side of the display panel;
an optical clear adhesive layer, disposed on a surface of a side of the touch panel away from the display panel, the optical clear adhesive layer encircling to form a vacuum region close to an edge of the touch panel;
a diffuse reflection film layer disposed in the vacuum region; and
a cover plate disposed on a surface of a side of the optical clear adhesive layer and the diffuse reflection film layer away from the display panel.

2. The touch display device as claimed in claim 1, wherein the diffuse reflection film layer fully fills the vacuum region.

3. The touch display device as claimed in claim 1, wherein material of the diffuse reflection film layer is polyethylene terephthalate.

4. The touch display device as claimed in claim 1, wherein a shape of the optical clear adhesive layer is a ring shape.

5. The touch display device as claimed in claim 1, wherein a shape of the touch panel is same as a shape of the display panel; and
a size of the touch panel is same as a size of the display panel.

6. A manufacturing method for a touch display device comprising following steps:
attaching a touch panel on an upper surface of a display panel, and an edge of the touch panel corresponding to an edge of the display panel;
attaching strip adhesive blocks on an upper surface of the touch panel, and a location of the strip adhesive blocks disposed on an edge of the touch panel, and at least one of the strip adhesive blocks encircling to form a vacuum region;
disposing a diffuse reflection film in the vacuum region, and attaching the diffuse reflection film to an upper surface of the touch panel to form a diffuse reflection film layer;
disposing a cover plate on an upper surface of the strip adhesive blocks and the diffuse reflection film layer, and making a middle section of the cover plate disposed opposite the touch panel and the display panel;
under a vacuum environment, performing a heating process on the cover plate and the touch panel to melt the strip adhesive blocks; and
applying ultraviolet to irradiate the cover plate and the touch panel to make the melted strip adhesive blocks cure into an optical clear adhesive layer.

7. The manufacturing method as claimed in claim 6, wherein a thickness of the optical clear adhesive layer is less than a thickness of the strip adhesive blocks;
a thickness of the diffuse reflection film layer is same as a thickness of the optical clear adhesive layer.

8. A manufacturing method for a touch display device, comprising following steps:
attaching a touch panel on an upper surface of a display panel, and attaching at least one of strip adhesive blocks and a diffuse reflection film layer on a bottom surface of a cover plate;
attaching the strip adhesive blocks and a bottom surface of the diffuse reflection film layer to an upper surface of the touch panel, and an edge of the touch panel corresponding to an edge of the strip adhesive blocks;
disposing a display panel under the touch panel to make the display panel align to the touch panel and the cover plate;
under a vacuum environment, performing a heating process on the cover plate and the touch panel to melt the strip adhesive blocks; and
a step of curing, applying ultraviolet to irradiate the cover plate and the touch panel to make the melted strip adhesive blocks cure into an optical clear adhesive layer.

9. The manufacturing method as claimed in claim 8, wherein disposing the touch panel and the diffuse reflection film layer comprises:
attaching the strip adhesive blocks on a preset location of a lateral surface of the cover plate, and the strip adhesive blocks encircling to form a vacuum region; and
disposing a diffuse reflection film in the vacuum region, and attaching the diffuse reflection film to a surface of the touch panel to form the diffuse reflection film layer.

10. The manufacturing method as claimed in claim 8, wherein disposing the touch panel and the diffuse reflection film layer comprises:
attaching the touch panel on an upper surface of the display panel, and an edge of the touch panel corresponding to an edge of the display panel.
